(19) United States
(12) Patent Application Publication
(10) Pub. No.: US 2005/0092347 A1
(43) Pub. Date: May 5, 2005

(54) Handy dental flosser

(76) Inventor: Sheng-Fa Fan, Kaohsiung (TW)

Correspondence Address: Cooper & Dunham LLP, 1185 Avenue of the Americas, New York, NY, 10036, US

(21) Appl. No.: 10/701,248

(22) Filed: Nov. 4, 2003

(51) Int. Cl. A61C 15/00

(52) U.S. Cl. 132/325

(57) ABSTRACT

A handy dental flosser has a housing (10) with a body and an extending tube (17), a winding wheel (11) rotatably attached inside the body of the housing (10), a string of dental floss (14) wound on the winding wheel (11) and tied to a distal end of the extending tube (17), and a locking device mounted on the housing (10) to detachably engage with the winding wheel (11) to release the dental floss. Thereby, the dental floss is easily replaced to renew a section between the winding wheel (11) and the distal end of the extending tube (17). Moreover, the handy dental flosser is conveniently used by one hand to clean teeth.

### BACKGROUND OF THE INVENTION

1. Field of the Invention

The present invention relates to a handy dental flosser, and more particularly to a handy dental flosser that is operated with one hand without putting fingers into a user's mouth and uses a short section of the dental floss for each time.

2. Description of Related Art

Food particles that often stick between teeth after a meal may cause decay sooner or later if the particles are not removed from the teeth. A conventional method to remove the food particles is to use a toothpick or a string of floss. However, the toothpick is usually made of wood and easily broken at a sharp end and when using it would be scratched and splintered in the teeth. The sharp end of the toothpick becomes another residues needed to be removed. Furthermore, the toothpick can not clean the teeth well since the toothpick is not entirely inserted into gaps between teeth.

Compared to the toothpick functioned, the dental floss is a better way to clean the oral cavity since that can easily enter the gaps between the teeth. However, the dental floss has to be pulled taut between two fingers so as to enter an opened mouth. With the finger of one hand inserted to the mouth would not be sanitary because of bacteria attached on the finger that may contaminate the oral cavity. Besides of that, the dental floss has to be wound around the fingers to achieve the firm tension yet that makes a long section of the dental floss becoming unused and wasted.

The present invention has arisen to mitigate the disadvantages of the toothpick and dental floss methods of cleaning oral cavity.

### SUMMARY OF THE INVENTION

The first objective of the present invention is to provide a handy dental flosser that is conveniently operated with one hand.

The second objective of the present invention is to provide a handy dental flosser that utilizes a short section of the dental floss to clean an oral cavity for each time.

There are the descriptions as the below described make the benefits of the present invention become apparent, which has the appropriated reference to the accompanying drawings.

### BRIEF DESCRIPTION OF THE DRAWINGS

FIG. 1 is an exploded perspective view of the handy dental flosser in accordance with the present invention;

FIG. 2 is a cross-sectional front plane view of the handy dental flosser in assembly;

FIG. 3 is a cross-sectional side plane view of the handy dental flosser;

FIG. 4 is an operationally cross-sectional side plane view of the handy dental flosser;

FIG. 5 is a partially enlarged cross-sectional side plane view of a distal end of the handy dental flosser;

FIG. 6 is an operationally cross-sectional side plane view of the distal end of the handy dental flosser in FIG. 5; and

FIG. 7 is a cross-sectional top plane view of an enlarged portion of a winding wheel and a side-cover in the handy dental flosser.

### DETAILED DESCRIPTION OF THE PREFERRED EMBODIMENT

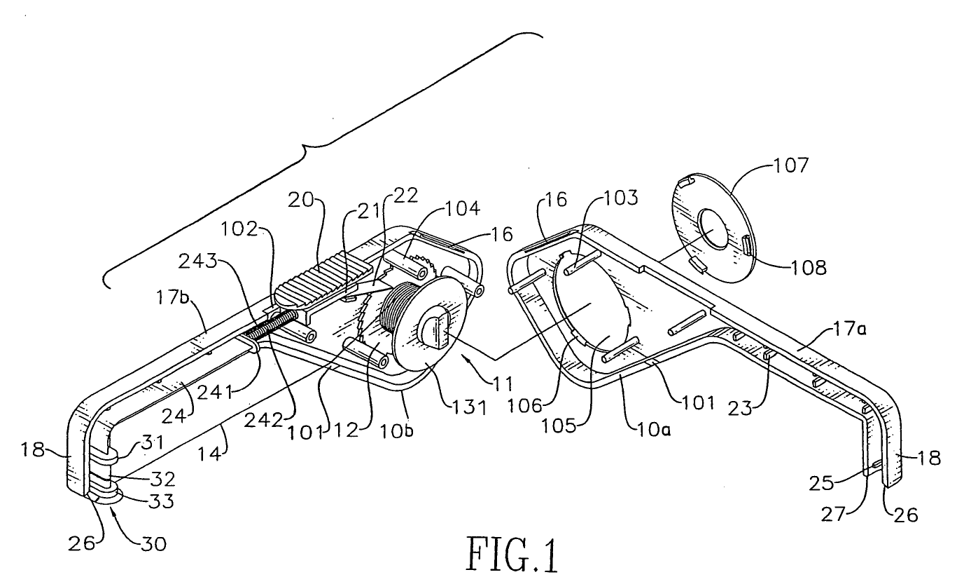

As shown in FIG. 1, a handy dental flosser in accordance with the present invention comprises a housing (10) with an extending tube, a winding wheel (11) rotatably attached inside the housing (10), a string of dental floss (14) wound on the winding wheel (11) and tied to a distal end of the extending tube, and a locking device mounted on the housing (10) to detachably engage with the winding wheel (11) and selectively open the extending tube.

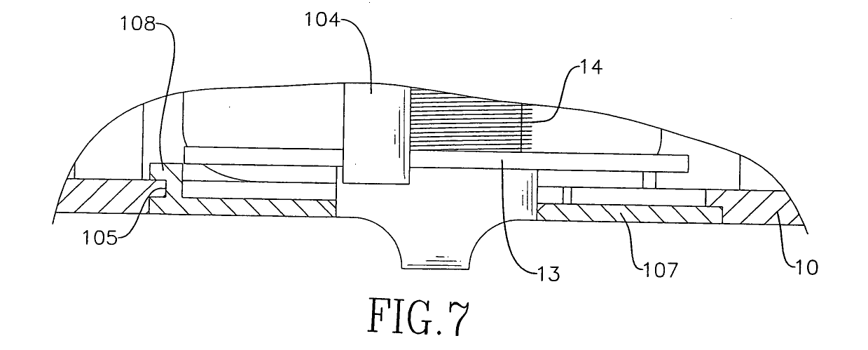

With reference to FIGS. 1, 2 and 7, the housing (10) is composed of two symmetrical first and second shells (10a, 10b), and each shell (10a, 10b) has a body and an extending arm (17a, 17b) protruding from the body. Multiple positioning posts (103) are formed on an inner periphery at the body of the first shell (10a) and multiple sleeves (104) are formed on an inner periphery at the body of the second shell (10b). The multiple sleeves (104) can be correspondingly engaged with the multiple positioning posts (103), whereby, the two shells (10a, 10b) are combined together to complete the housing (10). A first limiting flange (23) is formed on the inner periphery of the first shell (10a) between the body and the extending arm (17a) and a second limiting flange (25) is formed near a distal end inside the extending arms (17a) of the first shell (10a). After combining the two shells (10a, 10b) together, the extending arms (17a, 17b) construct the extending tube (17). Additionally, a slit (102) is defined on a top face of the housing (10) as of attaching the locking device, and the extending tube (17) further has a bent portion (18) extending downward at a distal end of the extending tube (17). A recess (16) is defined on an outer periphery of the housing (10) for receiving other accessory likely as one toothpick. (not shown).

The winding wheel (11) rotatably attaches to then inner periphery of second shell (10b) at the body in the housing (10) and an opening (105) as defined in the first shell (10a) is allowed the winding wheel (11) to pass through. A round side-cover (107) with a hole (not numbered) is detachably attached to the first shell (10a) to cover the opening (105). Wherein, the side-cover (107) has multiple hooks (108) formed at edges of the side-cover (107) and the opening (105) further has multiple cutouts (106) symmetrically defined at edges of the opening (105). Thereby, the side-cover (107) rotates to move the hooks (108) in conjunction to the cutouts (106) so that the side-cover (107) is firmly engaged on the housing (10).

The winding wheel (11) is composed of a toothed plate (12), a driving plate (13), and a middle rod connecting between the, toothed plate (12) and the driving plate (13). The driving plate (13) has a knob (131) which emerges out of the housing (10) via the hole of the side-cover (107). Whereby, the winding wheel (11) is enabled to be rotated by driving the knob (131) on the driving plate (13).

The locking device is composed of a trigger block (20) movably attached on the housing (10), a locking sheet (22), a shaft (242) attached in front of the trigger block (20), a resilient sheet (24) and a floss-tying block (30) connected to the resilient sheet (24). The locking sheet (22) is a V-shaped model and has an immovable end (not numbered) attached to the trigger block (20) and a locking end detachably engaged with the toothed plate (12) on the winding wheel (11).

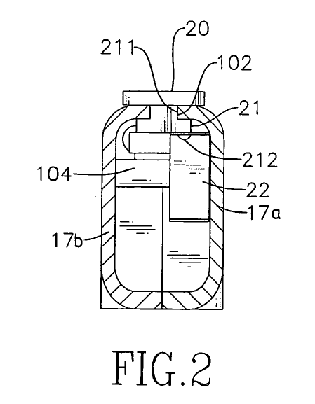

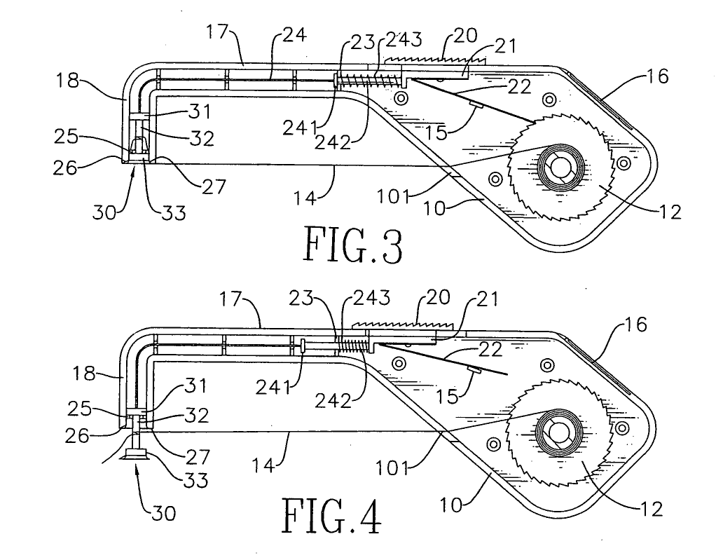

With further reference to FIG. 2, the trigger block (20) has an I-shaped cross-sectional configuration, which is mounted on the top of the housing (10) and partially enters into the housing (10) via the slit (102). The trigger block (20) movably mounted on the housing (10) is allowed to move forwards or backwards. Additionally, a stub (212) with an enlarged head is formed on a bottom face of the inner plate (21) and the immovable end of the locking sheet (22) is attached to the trigger block (20) by means of securing on the stub (212). The shaft (242) is constrained inside the extending tube (17) and defined of a front end and a rear end, wherein the front end of the shaft (242) is connected to the resilient sheet (24) and the rear end is attached to the trigger block (20). The shaft (242) has a spring (243) surrounding around and is located between the trigger block (20) and the first limiting flange (23) inside the housing (10), as to provide an elastic force to the trigger block (20). The resilient sheet (24) extends from the front end of the shaft (242) to pass through the extending tube (17) to connect with the floss-tying block (30). The floss-tying block (30) is retractably attached to a distal end of the bent portion (18). The floss-tying block (30) has an I-shaped cross section with an upper plate (31), a lower plate (33), and a connecting rod (32). The upper plate (31) is received inside the extending tube (17) and constrained by the second limiting flange (25). The connecting rod (32) passes by the second limiting flange (25) and is adapted to tie the dental floss. The lower plate (33) has a larger diameter than an inner diameter of the bent portion (18) so that the lower plate (30) is enabled to close the bent portion (18) when the trigger block (20) moves backwards.

Additionally, a sharp edge (26) is formed at a front end of an opening (not numbered) of the bent portion (18) and an obtuse edge (27) is formed at a rear end of the opening of the bent portion (18). The lower plate (33) covers the opening of the bent portion (18) and then prevents users from being injured by the sharp edge (26).

The string of dental floss (14) with a free end is wound on the winding wheel (11) and passes through the housing (10) via a through hole (101). The free end of the dental floss (14) is detachably wound on the connecting rod (32) to be extended between the body and the distal end of the bent portion (18).

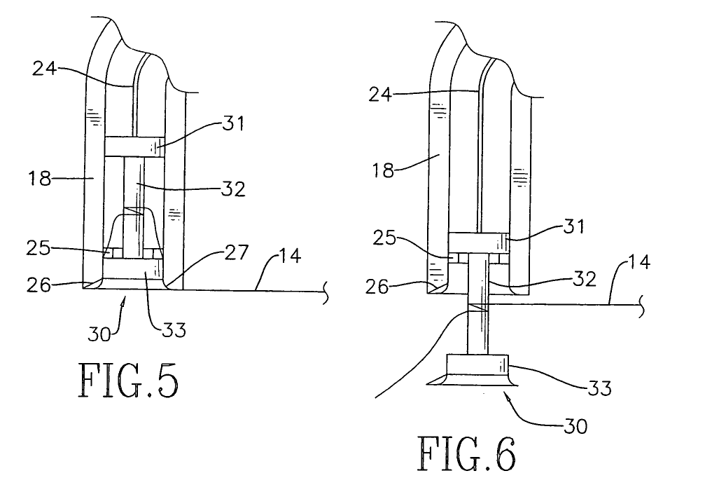

With reference to FIGS. 4, 5, and 6, when the handy dental flosser is operated to provide a new section of the dental floss (14), the trigger block (20) is pushed forward to make the locking end of the locking sheet (22) disengage from the toothed plate (12) of the winding wheel (11). The floss-tying block (30) is pushed out from the opening of the bent portion (18). The dental floss (14) is loosened and easily detached from the connecting rod (32). Then, the dental floss (14) is drawn out to place a new section of the dental floss between the winding wheel (11) and the floss-tying block (30). Then, the trigger block (20) is released to automatically move backwards by an elastic force of the spring (243) to make the locking end of the locking sheet (22) engage with the winding wheel (11) again. Meanwhile, the floss-tying block (30) is retracted into the bent portion (18) to cover the opening and fasten the dental floss (14) at the free end. Whereby, the new section of dental floss (14) is fastened between the winding wheel (11) and the floss-tying block (30). The winding wheel (11) is enabled to be rewound to further fasten the dental floss (14) for use since the toothed plate (12) has multiple dents, wherein each dent is composed of a vertical edge and a smooth edge and all smooth edges are unidirectional. Additionally, a residue of dental floss (14) is enabled to be cut off by the sharp edge (26) to keep the handy dental flosser neat.

After fastening the new section of the dental floss, the bent portion (18) is inserted into a user's mouth to clean gaps between the teeth. Therefore, the user operates the handy dental flosser with one hand and does not need to open mouth wide to an extreme position since the bent portion (18) is smaller than a user's fingers. Additionally, a great portion of dental floss (14) can be saved for the reason of that wound on fingers is much wasted resource than such the handy dental flosser utilized small portion of the dental floss (14). Moreover, the user of the handy dental flosser can escape from any mouth contamination incurred, compared to utilize dental floss with the finger put into the oral cavity.

Although the invention has been explained in relation to its preferred embodiment, it is to be understood that many other possible modifications and variations can be made without departing from the spirit and scope of the invention as hereinafter claimed.

1. A handy dental flosser comprising:
a housing (10) with a body and an extending tube (17) protruding from the body;
a winding wheel (11) rotatably attached inside the body of the housing (10), wherein the winding wheel (11) comprises a toothed plate (12) and a driving plate (13) and a middle rod connecting between the toothed plate (12) and the driving plate (13);
a string of dental floss (14) wound on the middle rod of-the winding wheel (11) and tied to a distal end of the extending tube (17); and
a locking device mounted on the housing (10) to detachably engage with the winding wheel (11).

2. The handy dental flosser as claimed in claim 1, wherein the housing (10) further has a first limiting flange (23) formed on an inner periphery of the housing (10) between the body and the extending tube (17), and a second limiting flange (25) formed on the inner periphery near the distal end of the extending tube (17); and
the locking device comprises a trigger block (20) movably attached on the housing (10), a locking sheet (22) mounted under the trigger block (20) to detachably engage with the toothed plate (12) of the winding wheel (11), a shaft (242) attached in front of the trigger block (20) and being limited by the first limiting flange (23), and a floss-tying block (30) connected to the shaft (242) to operationally block the extending tube (17) and being limited by the second limiting flange (25).

3. The handy dental flosser as claimed in claim 2, wherein the shaft (242) has a spring (243) surrounding around the shaft to provide an elastic force to drive the trigger block (20) back.

4. The handy dental flosser as claimed in claim 3, wherein the housing (10) further has a bent portion (18) formed at the distal end of the extending tube (17); and
the locking device further has a resilient sheet (24) passing through the extending tube (17) and the bent portion (18) mounted between the shaft (242) and the floss-tying block (30).

5. The handy dental flosser as claimed in claim 2, wherein the locking sheet (22) is V-shaped and has an immovable end attached under the trigger block (20) and a locking end detachably engaged with the toothed plate (12) of the winding wheel (11).

6. The handy dental flosser as claimed in claim 3, wherein the locking sheet (22) is V-shaped and has an immovable end attached under the trigger block (20) and a locking end detachably engaged with the toothed plate (12) of the winding wheel (11).

7. The handy dental flosser as claimed in claim 4, wherein the locking sheet (22) is V-shaped and has an immovable end attached under the trigger block (20) and a locking end detachably engaged with the toothed plate (12) of the winding wheel (11).

8. The handy dental flosser as claimed in claim 2, wherein the floss-tying block (30) has an I-shaped cross section and has an upper plate (31), a lower plate (33) and a connecting rod (32) extending between the upper plate (31) and the lower plate (33);
wherein the upper plate (31) is accommodated inside the extending tube (17) and limited by the second limiting flange (25);
wherein the lower plate (33) has a diameter larger than an inner diameter of the extending tube (17) to block the extending tube (17).

9. The handy dental flosser as claimed in claim 3, wherein the floss-tying block (30) has an I-shaped cross section and has an upper plate (31), a lower plate (33) and a connecting rod (32) extending between the upper plate (31) and the lower plate (33);
wherein the upper plate (31) is accommodated inside the extending tube (17) and limited by the second limiting flange (25);
wherein the lower plate (33) has a diameter larger than an inner diameter of the extending tube (17) to block the extending tube (17).

10. The handy dental flosser as claimed in claim 4, wherein the floss-tying block (30) has an I-shaped cross section and has an upper plate (31), a lower plate (33) and a connecting rod (32) extending between the upper plate (31) and the lower plate (33);
wherein the upper plate (31) is accommodated inside the bent portion (18) of the extending tube (17) and limited by the second limiting flange (25);
wherein the lower plate (33) has a diameter larger than an inner diameter of the extending tube (17) to block the bent portion (18) of the extending tube (17).

11. The handy dental flosser as claimed in claim 7, wherein the floss-tying block (30) has an I-shaped cross section and has an upper plate (31), a lower plate (33) and a connecting rod (32) extending between the upper plate (31) and the lower plate (33);
wherein the upper plate (31) is accommodated inside the bent portion (18) of the extending tube (17) and limited by the second limiting flange (25);
wherein the lower plate (33) has a diameter larger than an inner diameter of the extending tube (17) to block the bent portion (18) of the extending tube (17).

12. The handy dental flosser as claimed in claim 11, wherein the housing (10) further has an opening (105) defined in the housing (10) and a side-cover (107) with a hole detachably covering the opening (105); and
the winding wheel (11) further has a knob (131) formed on an outer face of the driving plate (13) to emerge out of the housing (10) via the hole of the side-cover (107);
whereby, the winding wheel (11) is enabled to be rotated by driving the knob (131).

13. The handy dental flosser as claimed in claim 12 , wherein the housing (10) is composed of two symmetrical shells (10a, 10b), each shell has a body and an extending arm protruding from the body;
multiple positioning posts (103) are formed on an inner periphery at the body of one shell; and
multiple sleeves (104) are formed on an inner periphery at the body of the other shell to correspondingly engage with the multiple positioning posts (103).

14. The handy dental flosser as claimed in claim 13, wherein the housing (10) further has a recess (16) defined in an outer periphery of the housing (10).

15. The handy dental flosser as claimed in claim 1, wherein a sharp edge (26) is formed at a front edge of the distal end of the extending tube (17) and an obtuse edge (27) is formed at a rear edge of the distal end of the extending tube (17).

16. The handy dental flosser as claimed in claim 3, wherein a sharp edge (26) is formed at a front edge of the distal end of the extending tube (17) and an obtuse edge (27) is formed at a rear edge of the distal end of the extending tube (17).

17. The handy dental flosser as claimed in claim 4, wherein a sharp edge (26) is formed at a front edge of the distal end of the extending tube (17) and an obtuse edge (27) is formed at a rear edge of the distal end of the extending tube (17).

18. The handy dental flosser as claimed in claim 7, wherein a sharp edge (26) is formed at a front edge of the distal end of the extending tube (17) and an obtuse edge (27) is formed at a rear edge of the distal end of the extending tube (17).

19. The handy dental flosser as claimed in claim 11, wherein a sharp edge (26) is formed at a front edge of the distal end of the extending tube (17) and an obtuse edge (27) is formed at a rear edge of the distal end of the extending tube (17).

20. The handy dental flosser as claimed in claim 14, wherein a sharp edge (26) is formed at a front edge of the distal end of the extending tube (17) and an obtuse edge (27) is formed at a rear edge of the distal end of the extending tube (17).
